(19) United States
(12) Patent Application Publication
(10) Pub. No.: US 2024/0245005 A1
(43) Pub. Date: Jul. 25, 2024

(54) END EFFECTOR FOR ROBOTIC REMOVAL OF A PART OF A CROP AND MANUFACTURING METHOD THEREOF

(71) Applicant: PRIVA KOMPANO GROUP B.V., De Lier (NL)

(72) Inventors: Ronald ZEELEN, De Lier (NL); Edwin Bastiaan LORSHEIJD, Schiedam (NL)

(21) Appl. No.: 18/564,161

(22) PCT Filed: May 30, 2022
(86) PCT No.: PCT/NL2022/050295

§ 371 Date: Nov. 27, 2023

(30) Foreign Application Priority Data
May 28, 2021 (NL) 2028330

(51) Int. Cl. A01D 46/30

(52) U.S. Cl. CPC A01D 46/30

(57) ABSTRACT

The present invention relates to a device for separating crop parts from crop (11), the device comprising a carrier (10) with gripping and cutting means (100). The gripping means comprise rotatable elements disposed opposite one another, between which a passage (P) is delimited for receiving the crop part. The rotatable elements comprise a pair of elongated rotors (3a, 3b) parallel to one another. Each rotor is provided with a screw profile (39) along its length and is coupled at a first longitudinal end (31) to a drive (27) for rotating the rotors when in operation. A capturing opening in the direction parallel to the rotation axes (A1, A2) at a second end (32) of the rotors. The screw profiles comprise a capturing zone portion (37) and a cutting zone portion (35). The cutting means (9) are arranged stationary adjacent to the cutting zone portion (35).

### FIELD OF THE INVENTION

The present invention relates to a device for separation from a crop of a crop part, the crop part being a stalk, flower, fruit, leaf, twig or branch; the device comprising a carrier provided with gripping means for the crop part and cutting means for cutting the crop part from the crop when the crop part is in the grip of the gripping means, the gripping means comprising rotatable elements disposed opposite one another, between which a passage opening is delimited for uptaking the crop part to be separated. The invention further relates to an elongated rotor for such a device and a method of manufacturing such a rotor, as well as to a method for separation of a crop part from a crop

### BACKGROUND ART

Such a device and method for separation are known from WO 2009/128711 A1. In the described device, the gripping means comprise rotatable elements disposed opposite one another, between which a nip is delimited for the uptake of said crop part to be removed and wherein the cutting means are arranged such that the cutting point of the crop part lies in the extension of this nip. During cutting, the cutting blade is moved such that the cutting edge moves along the extension of the nip, in order to cut the crop part in order to separate the crop part from the crop. During cutting, small particles and saps, which are often sticky, escape from the crop in the cutting blade area. These particles and saps are found to collect on the device, and restrict the movability of the cutting blade over time if not regularly cleaned off.

### SUMMARY OF THE INVENTION

It is an object of the invention to provide a device and method for separation from a crop of a crop part with improved functional behaviour, such that it is able to perform more robustly. It is a further object of the invention to achieve this improved functional behaviour with the use of relatively small motors.

According to the present invention, there is provided, a device for separation from a crop of a crop part, the crop part being a stalk, flower, fruit, leaf, twig or branch; the device comprising a carrier provided with gripping means for the crop part and cutting means for cutting the crop part from the crop when the crop part is in the grip of the gripping means; the gripping means comprising rotatable elements disposed opposite one another, between which a passage opening is delimited for uptaking the crop part to be separated, wherein the rotatable elements comprise a pair of elongated rotors, with a rotation axis of the rotors parallel to one another, wherein each rotor is provided with a screw profile along the length of the rotor, the rotors coupled at a first longitudinal end thereof to a drive for rotating the rotors when in operation, and provided with a capturing opening in the direction parallel to the rotation axes at a second end thereof, wherein the screw profiles comprise at least a capturing zone profile portion and a cutting zone profile portion, in which the capturing zone profile portion is adjacent to the capturing opening and the cutting zone profile portion is between the capturing zone profile portion and the first longitudinal end, and the cutting means are arranged stationary adjacent to the cutting zone profile portion.

By positioning the cutting means spaced apart from the gripping means reduces the risk of blocking the cutting means by the crop part or debris caused by the cutting process.

According to an embodiment there is provided a device as described above wherein one of the rotors has the screw profile with a right handed rotation, the other of the rotors has the screw profile with a left handed rotation opposite to the right-handed rotation of the screw profile of the one rotor and wherein the drive is configured for rotating the rotors in opposite rotational direction relative to each other.

The counter rotation provides that the crop part is moved through the opening between the rotors.

According to an embodiment there is provided a device as described above, wherein the screw profile further comprises a gripping zone profile portion between the capturing zone profile portion and the cutting zone profile portion of the respective rotor.

The gripping zone provides that the crop part is pulled away from the crop (main stem) in a direction perpendicular to the direction caused by the screw profiles on the rotors. provides better separation before cutting.

According to an embodiment there is provided a device as described above wherein the cutting means comprise a first cutting blade arranged at a first side of the passage opening adjacent to the cutting zone profile portion, with a cutting edge of the first cutting blade facing towards the capturing opening, and wherein the first cutting blade preferably is arranged such that the cutting edge is in a fixed position with respect to a longitudinal direction of the rotors.

The position of the cutting blade allows to cut the crop part by the movement of the crop part between the rotors: the position of the cutting blade is fixed relative to the length of the rotors.

According to an embodiment there is provided a device as described above, comprising a releasing zone profile portion between the cutting zone profile portion and the first end.

The releasing zone allows to handle the crop part after cutting, for example to eject the crop part at a specified position.

According to an embodiment there is provided a device as described above, wherein the pitch of the screw edge diminishes along either a length of the rotor or at least a length of capturing zone profile portion.

The change of the screw pitch improves the capturing of the crop part between the rotors.

According to an embodiment there is provided a device as described above, wherein the gripping zone profile portion comprises teeth in between the screw edges.

The provision of the teeth improves the grip on the crop part before the crop part enters the cutting zone.

According to an embodiment there is provided a device as described above, wherein the teeth are extending substantially along the length of the rotor between adjacent screw edges.

According to an embodiment there is provided a device as described above wherein the minor diameter of the rotor (i.e. the diameter of the screw between the screw edges) is relatively larger in the cutting zone profile portion than in the capturing zone profile portion.

The diameter difference reduces the width of the passage opening and thus improves the grip in the cutting zone.

According to an embodiment there is provided a device as described above, wherein the rotor in the releasing profile zone portion is at least partly free from screw edges and comprises teeth extending substantially along the length of said zone.

Using this profile allows to hold the crop part after cutting until the crop part is to be released in a transverse direction.

According to an embodiment there is provided a device as described above, wherein the rotor is made from one or more materials selected from rubber, plastic, composite or metal.

According to an embodiment there is provided a device as described above, wherein for each of the capturing zone profile portion, gripping zone profile portion, cutting zone profile portion and the releasing zone profile portion of the rotor a material is selected from a group comprising rubber, plastic, composite and metal, independent from the selected material of the other portions.

Depending on the particular zone on the rotor a material can be selected with best properties (for example wear properties or gripping properties) for that zone.

According to an embodiment there is provided a device as described above, wherein the rotors are replaceable.

According to an embodiment there is provided a device as described above, wherein the rotors are detachably mounted on a pair of parallel axles.

This allows that the rotors can easily be mounted on or removed from the axle, requiring only minor effort of the user/operator.

According to an embodiment there is provided a device as described above, wherein the cutting means are arranged for tilting relative to a transport plane defined by the area set up by the pair of rotational axes of the rotors and the passage opening, in which the first cutting blade relative can be tilted relative to the transport plane.

This allows that the orientation of the cutting blade can be adjusted to the orientation of the main stem of the crop, if under oblique angle in the grip, to create a straight and smooth cut.

According to an embodiment there is provided a device as described above, wherein the first cutting blade can be tilted around an axis perpendicular to the transport plane and extending between the pair of rotors.

This allows that the orientation of the cutting blade can be further adjusted to the orientation of the stem of the crop to create a straight cut.

According to an embodiment there is provided a device as described above, wherein the first cutting blade can be tilted around an axis defined by the perpendicular connecting line between the axes of the pair of rotors.

This allows that the orientation of the blade can be further adjusted to the orientation of the stalk of the crop part to create a straight cut.

According to an embodiment there is provided a device as described above, further comprising a housing enveloping the rotors with first and second longitudinal openings along the passage opening and a nib at the level of the capturing opening.

The housing provides a shielding to capture only a crop part while the remainder of the crop is substantially protected.

According to an embodiment there is provided a device as described above, wherein the housing further comprises a wedge between the rotors and the cutting means, said wedge having an upper, narrow end close to or abutting the cutting blade edge and a lower, wide end at a base of the cutting means, adapted for directing the crop part away from the cutting means after passing the cutting blade edge.

Accordingly, the wedge provides that the crop part is displaced from the crop after the cutting.

According to an embodiment there is provided a device as described above, wherein the cutting means further comprises a second cutting blade arranged in the second longitudinal opening at a second side of the passage opening opposite the first side with a cutting edge of the second cutting blade positioned closer to the first longitudinal end than the cutting edge of the first cutting blade.

The arrangement with the second cutting blade provides the option to cut the stalk of the crop part a second time after the cutting action by the first cutting blade, for example to remove a part of the stalk damaged by the cutting action of the first blade or to shorten the cut stalk further.

According to an embodiment there is provided a device as described above wherein the housing is provided with a secondary release opening at the second side between the second cutting blade and the first longitudinal end.

According to an embodiment there is provided a device as described above, the device comprising a carrier provided with gripping means for the crop part and cutting means for cutting the crop part from the crop when the crop part is in the grip of the gripping means, the gripping means comprising rotatable elements disposed opposite one another, between which a passage opening is delimited for uptaking the crop part to be separated, wherein the rotatable elements comprise a pair of elongated rotors, with a rotation axis of the rotors parallel to one another, the rotors coupled at a first longitudinal end thereof to a drive for rotating the rotors when in operation, and provided with a passage opening between the two rotors, in which: the gripping means further comprises a spiral grabber, and the cutting means comprises a cutting blade; the spiral grabber and rotors being arranged in triangular arrangement such that the spiral grabber is at one side of the passage opening, and the cutting blade positioned at a base of the spiral grabber at a side facing away from the passage opening, wherein the spiral grabber has a rotation axis parallel to the rotation axes of the rotors, and the rotors are configured for counter-rotation relative to each other such that in use a crop part is captured between the rotors and enters the passage opening, the spiral grabber is configured for rotation to receive the crop part from the passage opening and transport the crop part along the rotation axis of the grabber towards the cutting blade.

This embodiment provides an alternative to the device as described above.

According to an embodiment there is provided a method for separation from a crop a crop part, the crop part being a stalk, flower, fruit, leaf twig or branch, by using a device as described above comprising: capturing the crop part in the capturing zone profile portion through the capturing opening, rotating the rotors to transport the crop part in inward direction from the capturing opening towards the cutting zone profile portion, and while in the cutting zone profile portion the rotors are moving the crop part along the cutting means such that the crop part is cut from the crop by a cutting blade of the cutting means.

According to an embodiment there is provided a method as described above, wherein the pair of rotors are configured to carry out a compensating movement relative to the crop part in operation, the compensating movement running in a same direction as the length axes of the parallel rotors.

This compensating motion provides that no pull is exerted on the crop while capturing and cutting the crop part.

According to an embodiment there is provided a method as described above, wherein the drive is additionally configured for reversely rotating the rotors to transport the crop part in an outward direction opposite to the inward direction to allow release of the captured crop part.

According to an embodiment there is provided a method as described above, wherein the method provides tilting the cutting blade relative to the orientation of the crop while in the cutting zone profile portion, such that the blade cuts the crop part relatively close to the central stem of the crop.

According to an embodiment there is provided an electronic controller coupled to a device as described above, for controlling the rotation of the rotors to carry out the method as described above.

A (programmable) controller can be coupled or integrated with the device as described above to provide control of the motions of the device during capturing and cutting.

According to an embodiment there is provided an elongated rotor for a device as described above, said rotor being provided with a screw profile along a length of the rotor, having a first longitudinal end which is adapted to be coupled to a drive for rotating the rotor when in operation and being provided with a capturing zone profile portion extending along a portion of the length of the rotor at a second longitudinal end, such that a capturing opening is formed at said second longitudinal end when two of said elongated rotors are held in parallel next to one another.

Such elongated rotor can be provided as a replaceable part of the device as described above.

Advantageous embodiments are further defined by the dependent claims.

### BRIEF DESCRIPTION OF THE DRAWINGS

The present invention will be described in more detail below, by way of example only, with reference to the accompanying drawings which are schematic in nature in which:

FIGS. 1A-1C show a schematic, perspective view of an example of the cutting of a leaf from a crop according to the present invention;

FIG. 2 shows a schematic view of a device according to an embodiment during the uptake of a crop part;

FIG. 3 shows an external side view of the gripping and cutting means of a device according to an embodiment;

FIG. 4 shows the gripping and cutting means of FIG. 3 with the cover removed;

FIG. 5 shows an exploded view of the gripping and cutting means of FIG. 3;

FIG. 6 shows a perspective view of the cover of the gripping and cutting means of FIG. 3;

FIG. 7 shows a schematic perspective view of the gripping and cutting means according to another embodiment;

FIGS. 8A-8B respectively show a schematic perspective and top view of the gripping and cutting means according to another embodiment;

FIG. 9 shows a perspective schematic view of gripping and cutting means according to an alternative embodiment.

In the drawings, similar or corresponding elements, features or structures are indicated by the same reference signs. The drawings are not intended to be on scale.

### DESCRIPTION OF EMBODIMENTS

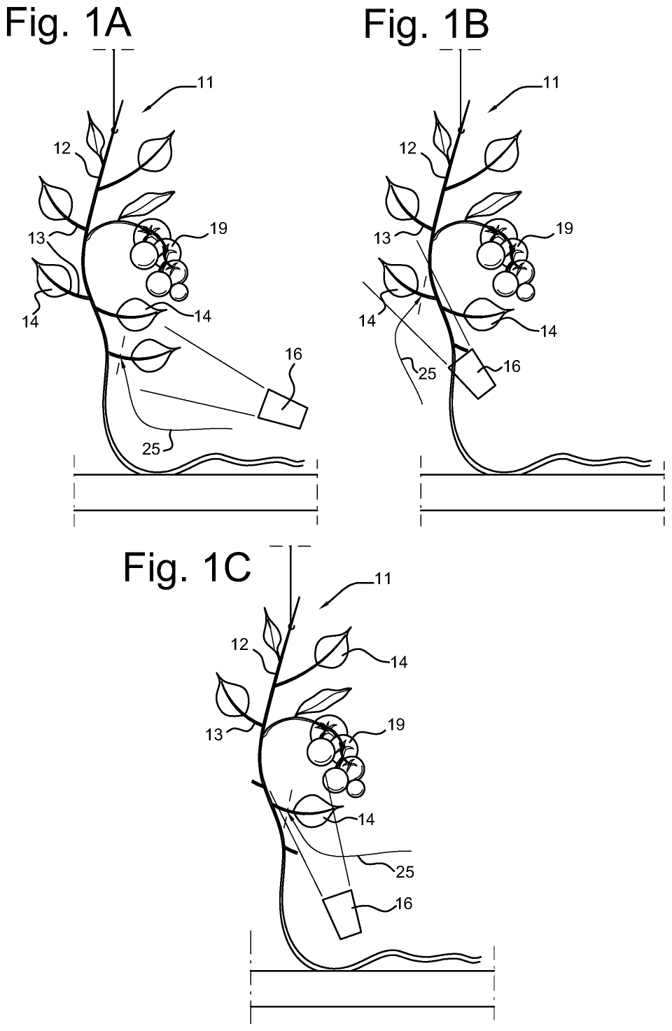

Use of the device according to the invention is described schematically in more detail with reference to FIGS. 1A-1C.

In FIG. 1A a crop 11 is indicated, comprising a central stem 12, a number of leaves 14 joined to the stem by a stalk 13 (petiole) and fruits 19. It will be understood that, depending on the crop (e.g. depending on its genus or species), the central stem 11 can have any conceivable shape and the same applies to any other parts of the crop. A schematically depicted camera 16 is present, whilst arrow 25 indicates a separation operation.

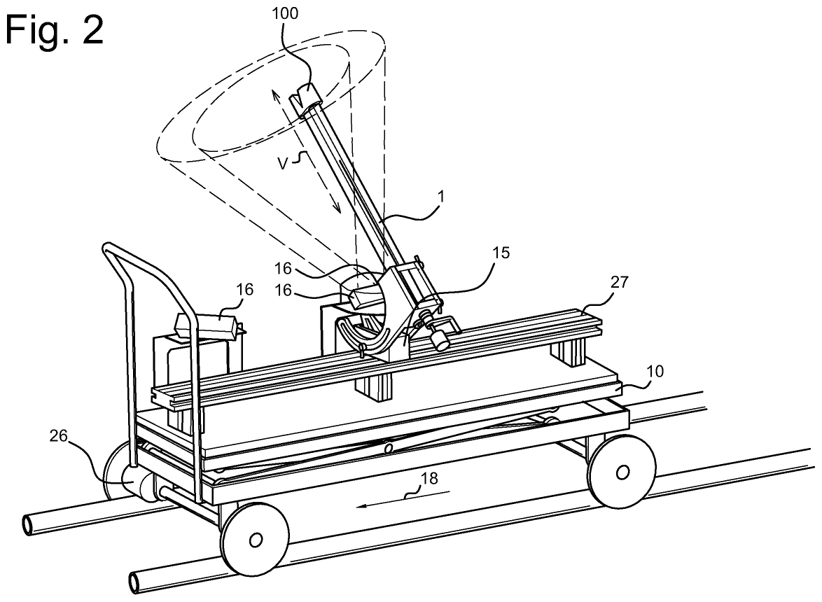

As is evident from FIG. 1A, the camera 16 is positioned to observe the crop under an angle such that it can see the attachment of a crop part, in this case the lowest of the leaves 14, to the central stem 12. A device for separating the crop part from the central stem 12, an example of which is depicted in FIGS. 2-7, are subsequently moved into the field of vision of the camera 16 in order to cut the stalk 13 from the lowest leaf 14 of the crop.

The removal not only comprises the cutting of the stalk from the stem, but also the removal of the leaf 14 and stalk 13 thus obtained away from the central stem 12.

Subsequently, the situation depicted in FIG. 1B may arise, in which the camera observes the next leaf 14, which has an unobstructed attachment to the central stem 12 under the camera's view angle. Again, a schematically depicted cutting manipulation of the relevant leaf 14 is performed, as indicated by arrow 25.

Subsequently or alternatively, the situation depicted in FIG. 1C may arise, which is similar to the situation depicted in FIG. 1B, but here fruits 19 are located directly above the leaf 14. The camera 16 is adapted to distinguish between fruit 19 and leaves 14, and a controller connected to the device is adapted to operate the device such that the leaf 14 will be removed, but not the fruit 19. The leaves may be cut from the crop in this manner step-by-step until the desired degree of leaf removal is achieved.

It will be understood that more than one camera can be used with the device, and that these more than one cameras may be positioned in various locations with respect to the device. It will further be understood that in the situation in FIGS. 1B and 1C, wherein the next leaf 14 is observed, this next leaf 14 can also be attached to the central stem of another crop 11 and/or the fruit 19 located directly above the next leaf 14 can be attached to the central stem of another crop. In the crop depicted in FIGS. 1A-1C, the observation by camera 16 takes place from beneath, independent of such a central stem 12, and the operation is performed by starting from a low proximity position and by working upwards, so that it is essentially irrelevant which central stem 12 the leaf 14 for removal is attached to. It will occur to the skilled person that the method and device may also be used on different crops, which may be approached from another direction than from below, and/or for harvesting the fruits.

In FIG. 2, a device according to an embodiment during the uptake of the crop part is shown. The device comprises a carrier 10, which for example is a pipe-rail trolley, with its own drive 26 and an arm 1 mounted thereon, holding a gripping and cutting means 100 according to the invention. In the depicted device, the arm 1 is mounted with a base 15, at the first end thereof, onto a top surface of the carrier 10 via a sled arrangement 27, such that the arm is moveable in its entirety along the length direction of the carrier 10.

The gripping and cutting means 100 is attached to the free end of the arm, which end is distal from the base 15. Three cameras 16 are arranged on the carrier 10, with two cameras being located adjacent to one another at the base of the arm, for observing a crop under an angle, and a third camera 16 positioned to observe the operational range of the arm 1, for observing any obstacles obstructing the arm 1. The carrier 10 is moved in the direction of the arrow 18 to the lower side of the main stem 12 of one of the crops. The cameras 16 then observe the crop from beneath. This observation is performed in the shape of a cone, as indicated in the Figure. With the aid of vision techniques, it is determined where a crop part such as a stem, flower, fruit, leaf, twig or branch to be removed is located. The arm 1 is subsequently manipulated by a control system and mechanism thereof (not shown), orienting the arm to obtain a desired angle with respect to the base 15, as well as some distance in the vertical direction V. The skilled person will understand that all conceivable displacements can be made possible, including, but not limited to rotation about the horizontal and vertical axes and translation along the longitudinal axis. Additionally, it will occur to the skilled person that alternative carriers and arm constructions may be used in the device.

During the use steps, as set out in the example of FIGS. 1A-1C, the gripping and cutting means 100 of the device implements the following functions:
Capturing the crop part;
Enclosing the crop part, thereby preventing the crop part from leaving the gripping and cutting means 100;
Retracting the crop part into the gripping and cutting means 100;
Cutting off the crop part by moving said crop part over a fixed cutting blade;
Holding the separated crop part whilst moving out of the crop; and
Ejection of the crop part.

The device is adapted to move the arm 1 during the retracting and cutting, to compensate for movement of the crop part through the gripping and cutting means 100, thereby preventing pulling forces being exerted onto the crop.

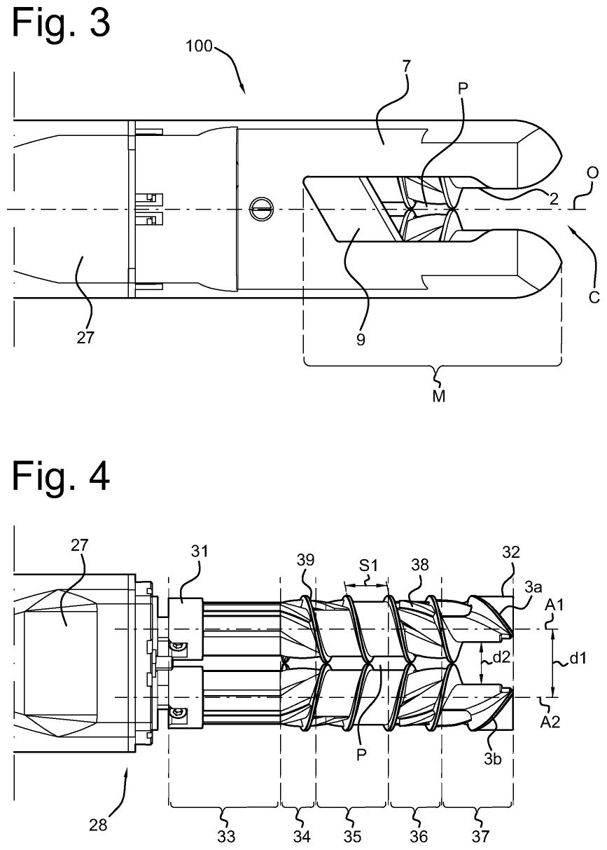

The features of the gripping and cutting means 100, which enable the abovementioned functions, are described in further detail with reference to FIGS. 3, 4, 5 and 6.

FIG. 3 shows an external side view of the gripping and cutting means 100 according to an embodiment of the invention, showing the means as comprising a drive-cover 27 and a housing 7, which envelops two elongated, parallel to one another, rotatable elements that extend from the drive-cover 27 and form the gripping means with a passage opening P between them. The housing 7 comprises a nib 2, which extends from an end proximal towards the drive-cover 27, causing the proximal end to have an opening called capturing opening C, toward said drive-cover, such that the nib 2 extends along a plane O defined between the two elongated rotatable elements. The nib 2 is terminated on one side of the housing by a first longitudinal opening M in which a cutting blade 9 is mounted (in some embodiments a first cutting blade), which is fixedly attached to the housing and forms the cutting means. On an opposite side of the housing 7, a second longitudinal opening (not shown) is provided parallel to the first longitudinal opening M. In operation, the cutting blade 9 is preferably positioned at the first longitudinal opening M between the housing 7 and the crop. The second longitudinal opening is facing away from the crop and functions as release opening for releasing the cut crop part.

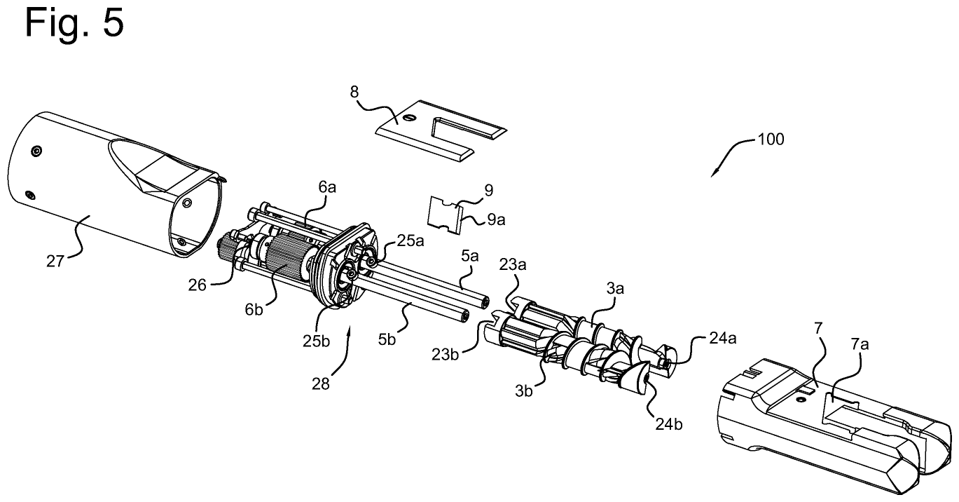

The rotatable elements are adapted to capture, enclose and retract a crop part, thereby moving the crop part over the cutting blade 9, resulting in the crop part being separated from the crop. FIG. 4 shows the gripping and cutting means 100 of FIG. 3, with the housing 7 removed, allowing a clear view of the rotatable elements. The rotatable elements comprise a pair of elongated rotors 3a, 3b, which are with a first end 31 connected to a drive that is located within the drive-cover 27, such that the rotors 3a, 3b are rotatable about respective rotation axes A1, A2 which are parallel to one another. A second end 32 of each respective rotor 3a, 3b is normally covered by the housing 7, with each respective end being on an opposite side of the nib 2 and the opening between the second ends 32 defining the capturing opening for crops. Each rotor 3a, 3b is provided with a screw profile 39 along the length of the rotor, with a first of the two rotors 3a having a right-handed rotation profile and a second of the two rotors 3b having a left-handed rotation profile such that the screw profiles of both rotors are symmetrical to one another around the plane O. The drive (shown in more detail in FIG. 5) is adapted to rotate the rotors in opposite rotational direction from one another, when in operation, causing the right-handed and left-handed screw profiles to rotate against each other and pull matter along the plane O inward towards the cutting blade 9. The translational movement caused by the counter-rotating screw profiles is compensated by an extending movement of the robot arm of the device during use. The rotors 3a, 3b are shown to have a number of different profile portions 33, 34, 35, 36, 37 along their longitudinal direction, in between adjacent flights of the screw profile 39, with each profile fulfilling another function during operation of the gripping and cutting means 100.

In an embodiment, the drive is additionally configured for a reversed translational movement of a crop part captured between the rotors by reversing the rotational direction to have the rotors move a captured part outward (i.e., away from the cutting blade 9). Advantageously, the reversed rotation allows to release any additional crop part that was captured inadvertently in addition to a ‘target’ crop part and to avoid that the additional crop part when captured, is torn out from the stem of the crop by movement of the device, after cutting the target crop part.

Each respective rotor 3a, 3b is provided with a capturing zone profile portion 37 extending from their second end, adjacent to the capturing opening. The capturing zone profile portion is such that the capturing opening defined between the two second longitudinal ends 32 is funnel-shaped, such that a distance d2 between an outer surface of both rotors, perpendicular to rotation axes A1, A2, is wider at the second longitudinal ends 32 than at the opposite end of the capturing zone profile 37. This funnel-shape corrects for deviations in positioning of the robot arm with respect to the crop part, or crop movements during the capturing of the crop part, and prevents crop parts with a dimension larger than the narrowest dimension of the funnel from entering in between the rotors 3a, 3b. Furthermore, the pitch S1 of each spiral profile 39 is shown to be greater in the capturing zone profile portion 37 than in the other profile portions (i.e., the pitch diminishes from the capturing zone profile 37 to a next adjacent profile zone). This greater pitch allows for the enclosure of crop parts which incidentally lie at larger positive or negative angles with respect to the plane O.

Adjacent the capturing zone profile portion, the gripping zone profile portion 36 is defined. This gripping zone profile portion 36 is provided with teeth, extending substantially perpendicular to and in between two adjacent flights of the screw profile 39. The gripping zone profile portion 36 is an optional portion, which may be designed with a specific crop in mind. Preferably each rotor 3a, 3b comprises 6 teeth per 360º of the rotor. The teeth of the rotors 3a, 3b may be set in line, such that they grip onto a crop part simultaneously, or staggered so that the teeth of the rotors 3a, 3b grip onto the crop part alternately, depending on the type of crop. Different shaped teeth, such as upright or angled with respect to the rotational axes A1, A2, may be used for different types of crops.

A cutting zone profile portion 35 is defined adjacent the gripping zone profile portion, at a longitudinal position of the rotors 3a, 3b which corresponds to a position of the cutting blade 9. The cutting zone profile portion 35 is adapted to pull the central stem of the crop relatively close to the cutting means, in a direction perpendicular to the rotor axes A1, A2, for providing a smooth cut close to the central stem during cutting, by the cutting blade at the side of the first longitudinal opening M.

Profile portions 33 and 34 form the release zone profile portion of the rotors 3a, 3b, between the cutting zone profile portion and the first longitudinal end 31. The release zone profile portion 33, 34 holds on to the separated crop part after cutting and transports it away from the cutting blade 9, thereby preventing the separated crop part from becoming stuck in the device's cutting blade area and allowing the crop part being ejected or released, optionally in a specified position, at the side of the second longitudinal opening.

The rotors 3a, 3b are preferably moulded, or 3D printed parts, which can be made completely from a single material or comprise segments made of different materials. Preferred materials for manufacturing the rotors are metals, plastics, composites and rubbers.

As indicated, different rotors may be designed and used for different crops. In a typical configuration used for a tomato crop, a distance d1 between the rotor axes A1, A2 is 20 mm and an outer diameter of each screw profile 39 is 19.75 mm, while the screw pitch S1 is 12 mm, except for in the capturing zone profile portion 37, where the screw pitch is 50 mm.

In a further embodiment, the screw pitch diminishes along all profile portions starting from a largest pitch at the capturing opening.

The device is adapted for allowing the rotors being replaced, such that the device is useable for different crops, or stages of crop growth. Hereto, the connection between the rotors 3a, 3b and the drive is relatively simple, as can be seen in the exploded view in FIG. 5. In the exploded view, the drive 26, normally covered by the drive-cover 27 and drive top-plate 28 is shown, which comprises two interconnected gearwheels 6a, 6b, interconnected such that in operation said gearwheels 6a, 6b counter-rotate. Each gearwheel is directly connected to a respective axle 5a, 5b, extending from an axis of rotation of the gearwheel, and forming a respective rotor axis A1, A2. The two axles 5a, 5b are parallel to one another and adapted for receiving the elongate rotors, thereby connecting each rotor 3a, 3b to the drive 26. In order to directly transfer rotation of the axles 5a, 5b to the rotors 3a, 3b, each axle 5a, 5b is at a first end, adjacent to the drive 26, provided with a protrusion 25a, 25b and each rotor 3a, 3b is at a respective first end 31 thereof provided with a corresponding element 23a, 23b for receiving the protrusion therein. The protrusions 25a, 25b and corresponding elements 23a, 23b allow the rotors 3a, 3b easily being slid over the axles 5a, 5b and connected to the drive 26 by matching up of these features. A second securing means for connecting the rotors 3a, 3b to the axles 5a, 5b may be added at the second longitudinal ends of the rotors 3a, 3b. Said securing means may, for example, be a bolt-connection to the free ends of the axles 5a, 5b, along the rotor axes A1, A2, through matching openings 24a, 24b in the second ends of the rotors 3a, 3b.

Further, FIG. 5 provides more detail on how the cutting blade 9 is attached to the housing. The blade 9 is secured to the housing via blade-plate 8, which is attached to the housing in correspondingly shaped knife-receiving recess 7a on the outer surface of the housing, such that the cutting blade 9 is sandwiched between a surface of the knife-receiving recess 7a and the blade-plate 8. Although alternative manners of attaching the cutting blade to the gripping means in a fixed longitudinal position with respect to the rotor axes will occur to the skilled person, the depicted configuration is particularly preferred, due to its simplicity and ease of access. The attachment of the blade-plate 8 to the housing 7 is preferably achieved through a bolt connection, which can simply be undone, such that the cutting blade 9 can be replaced and/or adjusted for obtaining a different, fixed cutting edge 9a height along the length direction of the rotors 3a, 3b. Together with a different set of rotors, adapted for a specific crop or crop growth stage, a specific matching cutting blade and/or blade plate 8 (each preferably with a shape adapted for the specific crop or crop growth stage as known to the skilled person) may be attached to the device, adapted for optimum cutting results of said specific crop or crop growth stage. The cutting blade may have a slanted cutting edge 9a, as depicted in FIG. 5, or a different shape, such as a straight edge or a V-shaped edge.

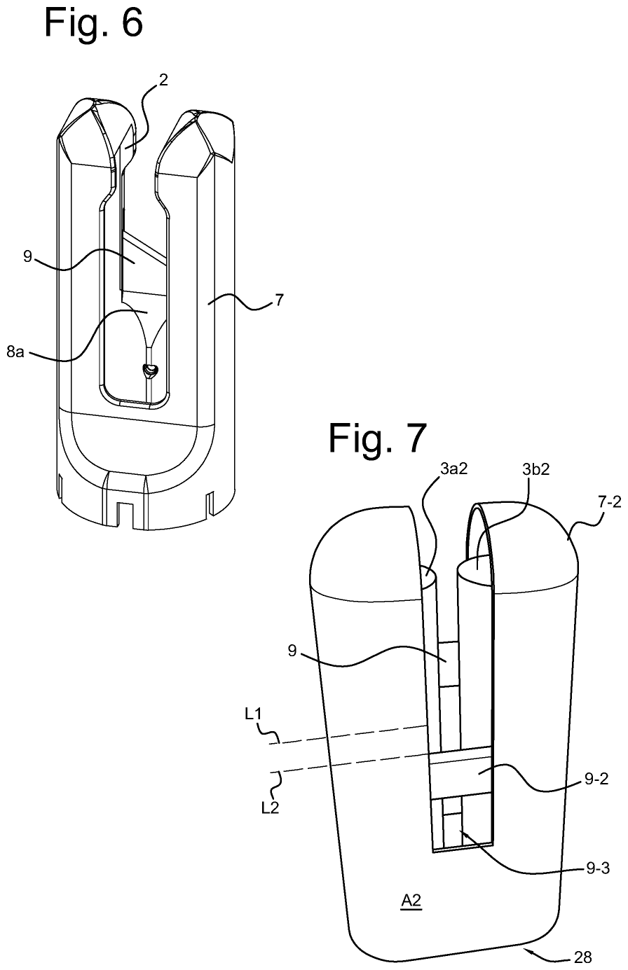

FIG. 6 shows a detailed side view of the housing 7, without the rest of the device being present, such that the inner wall of the housing 7 behind the cutting blade 9 is visible. The inner wall of the housing 7 behind the cutting blade 9 is shown to be provided with a wedge shaped element 8a, having a narrow upper edge abutting or adjacent to the blade 9 and comprising a downward sloping edge, leading away from a cutting plane of the cutting blade 9. The wedge shaped element 8a pushes the crop part away from the blade 9 after being separated from the crop by the blade.

Alternative to a fully fixed blade, a moveable cutting blade may be provided in the device, which moveable cutting blade has a fixed position with respect to the longitudinal direction of the rotors 3a, 3b, but is moveable with respect to the rotors to adjust for variations of the crop part being retracted, such as for example variations of angle with which the crop part extends from between the rotors 3a, 3b towards the cutting blade 9.

FIG. 7 shows a schematic perspective view of the gripping and cutting means according to another embodiment. The configuration shows a housing 7-2 encapsulating two elongate rotors 3a2, 3b2 which are parallel to one another, similar to the arrangement in the housing 7; 7-2 of the previous figures. In addition to the cutting blade 9 (in this embodiment a first cutting blade 9) which is arranged in a first side A1 of the cover that faces the crop during operation, the cutting means comprises a second cutting blade 9-2. The second cutting blade 9-2 is arranged at the second side A2 of the cover in the second longitudinal opening that is opposite to the first side A1 (not shown), in which the second side A2 is where the crop part that was separated from the crop is to be released. The edge of the second cutting blade 9-2 is positioned closer to the drive below the level L1 of the edge of the first cutting blade 9 (as projected on the second side A2): the longitudinal distance between the level L2 of the edge of the second cutting blade and the capturing opening is relatively larger than the longitudinal distance between the level of the edge of the first cutting blade 9 and the capturing opening.

The second cutting blade 9-2 in cooperation with the rotors provides that a stalk of the crop part that is separated from the crop part by the first cutting blade 9, is cut again by the second cutting blade 9-2. Due to the lower level L2 position of the second cutting blade relative to the first cutting blade 9, the second cut is carried out while the cut crop part is moved to the release zone portion, after the cut by the first cutting blade has taken place. In this manner, a portion of a stalk that may be damaged or bruised by the cutting action of the first cutting blade can be removed by the second cutting blade 9-2. During the cutting action of the first cutting blade, the crop part is separated from the crop. During the cutting by the second blade, the crop part is released from the gripping and cutting means. In an embodiment, the device can be moved to an external release zone (not shown) where the crop part is received, for example for the purpose of collection and/or packaging.

A secondary release opening 9-3 for the stalk part residue cut by the second cutting blade 9-2 is provided in the housing 7-2 at the side of the second longitudinal opening between the second cutting blade 9-2 and the level of the drive top plate 28.

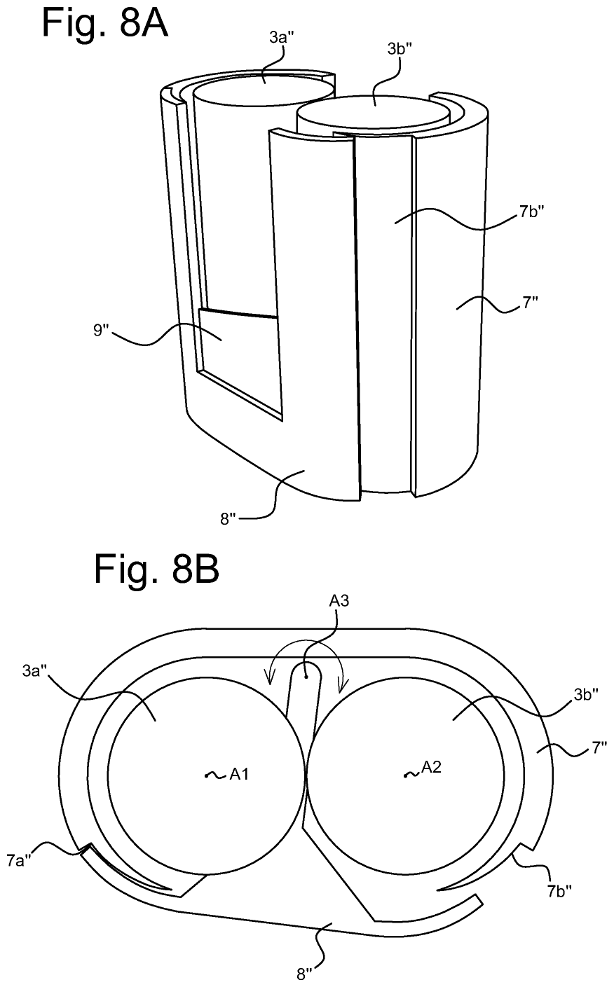

FIGS. 8A-8B respectively show a schematic perspective and top view of the configuration of the gripping and cutting means according to another embodiment of the invention having such an alternative blade configuration. The alternative configuration shows a housing 7″ encapsulating two elongate rotors 3a″, 3b″ which are parallel to one another, similar to the housing 7″ of the previous figures. Rather than the cutting blade being fixedly connected to the housing in between a blade plate and a recess in the housing, a wall of the blade plate 8″ which holds the blade 9″ forms a part of the housing 7″ surrounding the rotors 3a″, 3b″ and is pivotally connected to the housing, or alternatively to the drive or drive-cover, having a pivot axis A3 parallel to and in between the rotor axes A1, A2. Through the pivot axis, the wall of the blade plate 8″ holding the blade 9″ is moveable along a circular path, which is delimited on two sides by a longitudinal edge 7a″, 7b″ of the housing 7″. Preferably, the blade plate 8″ is adapted to have a neutral position in which the cutting plane is at equal distance from both rotor axes A1, A2.

Although the variation depicted in FIGS. 8A-8B is only rotatable around a pivot axis parallel to the rotor axes A1, A2, in similar fashion the cutting blade may be made rotatable around pivot axis perpendicular to the rotor axes A1, A2 alternatively or additionally.

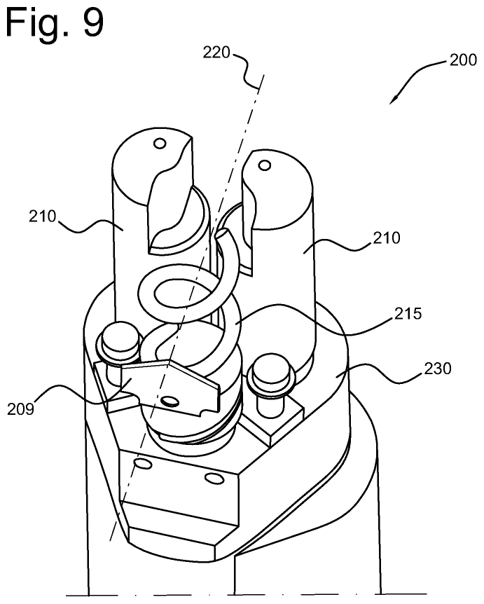

FIG. 9 shows a perspective schematic view of gripping and cutting means 200 according to an alternative embodiment.

In this alternative embodiment, the cutting and gripping means 200 comprise two parallel rollers 210 which are arranged for gripping a crop part (not shown) between the rollers. Adjacent, positioned at some distance from the rollers on the dividing line 220 between the rollers 210, a spiral grabber 215 is arranged with its rotation axis parallel to the rotation axes of the rollers. Both the rollers and the spiral grabber are coupled to a drive mechanism (not shown) in the mount 230 of the device. The spiral grabber is configured to rotate when a crop part is captured between the rollers 210. During the capturing the rollers rotate in opposite rotation and move an end of the crop part into a top of the spiral grabber which by its rotation grasps the crop part positioned in the top. The rotation of the spiral grabber further forces the crop part towards a cutting blade 209 that is adjacent to the foot of the spiral grabber. In operation, the cutting blade 209 will cut the crop part by the movement exerted by the spiral grabber, optionally in cooperation with a movement caused by the rollers.

The invention has been described with reference to the preferred embodiment. Obvious modifications and alterations will occur to the person skilled in the art upon reading and understanding the preceding detailed description. It is to be understood that the invention is limited only by the annexed claims and its technical equivalents i.e., including all such modifications and alterations insofar as they come within the scope of the appended claims. In this document and in its claims, the verb “to comprise” and its conjugations are used in their non-limiting sense to mean that items following the word are included, without excluding items not specifically mentioned. In addition, reference to an element by the indefinite article “a” or “an” does not exclude the possibility that more than one of the element is present, unless the context clearly requires that there be one and only one of the elements. The indefinite article “a” or “an” thus usually means “at least one”.

1. A device for separation from a crop of a crop part, the crop part being a stalk, flower, fruit, leaf, twig or branch; the device comprising:
a carrier provided with a grip for the crop part and a cutter for cutting the crop part from the crop when the crop part is in the grip,
the grip comprising rotatable elements disposed opposite one another, between which a passage opening is delimited for uptaking the crop part to be separated,
wherein the rotatable elements comprise a pair of elongated rotors, with a rotation axis of the rotors parallel to one another,
wherein each rotor is provided with a screw profile along the length of the rotor, the rotors coupled at a first longitudinal end thereof to a drive for rotating the rotors when in operation, and provided with a capturing opening in the direction parallel to the rotation axes at a second end thereof,
wherein the screw profiles comprise at least a capturing zone profile portion and a cutting zone profile portion, in which the capturing zone profile portion is adjacent to the capturing opening and the cutting zone profile portion is between the capturing zone profile portion and the first longitudinal end, and the cutter is arranged stationary adjacent to the cutting zone profile portion.

2. The device according to claim 1, wherein one of the rotors has the screw profile with a right handed rotation, the other of the rotors has the screw profile with a left handed rotation opposite to the right-handed rotation of the screw profile of the one rotor and wherein the drive is configured for rotating the rotors in opposite rotational direction relative to each other.

3. The device according to claim 1, wherein the screw profile further comprises a gripping zone profile portion between the capturing zone profile portion and the cutting zone profile portion of the respective rotor, and/or
wherein the device further comprises a releasing zone profile portion between the cutting zone profile portion and the first longitudinal end for releasing the cut crop part at a second side of the passage opening opposite the first side, and/or
wherein the rotor in the releasing profile zone portion is at least partly free from screw profiles and comprises teeth extending substantially along the length of said zone.

4. The device according to claim 1, wherein the cutter comprises a first cutting blade arranged at a first side of the passage opening adjacent to the cutting zone profile portion, with a cutting edge of the first cutting blade facing towards the capturing opening,
and wherein the first cutting blade is arranged such that the cutting edge is in a fixed position with respect to a longitudinal direction of the rotors.

5. (canceled)

6. The device according to claim 1, wherein the pitch of the screw profile diminishes along either a length of the rotor or at least a length of capturing zone profile portion.

7. The device according to claim 1, wherein the gripping zone profile portion comprises teeth in between the screw profiles, and/or
wherein the teeth are extending substantially along the length of the rotor between adjacent screw profiles.

8. (canceled)

9. The device according to claim 1, wherein the minor diameter of the rotor is relatively larger in the cutting zone profile portion than in the capturing zone profile portion.

10. (canceled)

11. The device according to claim 1, wherein the rotor is made from one or more materials selected from rubber, plastic, composite and metal, and/or
wherein for each of the capturing zone profile portion, gripping zone profile portion, cutting zone profile portion and the releasing zone profile portion of the rotor a material is selected from rubber, plastic, composite and metal, independently of material selected for the other portions.

12. (canceled)

13. The device according to claim 1, wherein the rotors are replaceable.

14. The device according to claim 13, wherein the rotors are detachably mounted on a pair of parallel axles.

15. The device according to claim 4, wherein the cutter is arranged for tilting relative to a transport plane defined by the area set up by the pair of rotational axes of the rotors and the passage opening, in which the first cutting blade can be tilted relative to the transport plane.

16. The device according to claim 15, wherein the first cutting blade can be tilted around an axis perpendicular to the transport plane and extending between the pair of rotors.

17. The device according to claim 15, wherein the first cutting blade can be tilted around an axis defined by the perpendicular connecting line between the rotation axes of the pair of rotors.

18. The device according to claim 1, further comprising a housing enveloping the rotors with first and second longitudinal openings along the passage opening and a nib at the level of the capturing opening.

19. The device according to claim 1, wherein the housing further comprises a wedge between the rotors and the cutter, said wedge having an upper, narrow end close to or abutting the cutting blade edge and a lower, wide end at a base of the cutter, adapted for directing the crop part away from the cutter after passing the cutting blade edge.

20. The device according to claim 4, wherein the cutter further comprises a second cutting blade arranged in the second longitudinal opening at a second side of the passage opening opposite the first side with a cutting edge of the second cutting blade positioned closer to the first longitudinal end than the cutting edge of the first cutting blade, and/or
wherein the housing is provided with a secondary release opening at the second side between the second cutting blade and the first longitudinal end.

21. (canceled)

22. A device for separation from a crop of a crop part, the crop part being a stalk, flower, fruit, leaf, twig or branch; the device comprising:
a carrier provided with a grip for the crop part and a cutter for cutting the crop part from the crop when the crop part is in the grip,
the grip comprising rotatable elements disposed opposite one another, between which a passage opening is delimited for uptaking the crop part to be separated,
wherein the rotatable elements comprise a pair of elongated rotors, with a rotation axis of the rotors parallel to one another,
the rotors coupled at a first longitudinal end thereof to a drive for rotating the rotors when in operation, and provided with a passage opening between the two rotors,
in which:
the grip further comprises a spiral grabber, and
the cutter comprises a cutting blade;
the spiral grabber and rotors being arranged in triangular arrangement such that the spiral grabber is at one side of the passage opening, and the cutting blade is positioned at a base of the spiral grabber at a side facing away from the passage opening,
wherein the spiral grabber has a rotation axis parallel to the rotation axes of the rotors, and
the rotors are configured for counter-rotation relative to each other such that in use a crop part is captured between the rotors and enters the passage opening, the spiral grabber is configured for rotation to receive the crop part from the passage opening and transport the crop part along the rotation axis of the grabber towards the cutting blade.

23. A method for separation from a crop a crop part, the crop part being a stalk, flower, fruit, leaf twig or branch, by using a device according to claim 1, the method comprising:
capturing the crop part in the capturing zone profile portion through the capturing opening,
rotating the rotors to transport the crop part in inward direction from the capturing opening towards the cutting zone profile portion, and
while in the cutting zone profile portion the rotors are moving the crop part along the cutter such that the crop part is cut from the crop by a cutting blade of the cutter.

24. The method according to claim 23, wherein the pair of rotors are configured to carry out in operation a compensating movement relative to the crop part, the compensating movement running in a same direction as the longitudinal axes of the parallel rotors.

25. The method according to claim 23, wherein the drive is additionally configured for reversely rotating the rotors to transport the crop part in an outward direction opposite to the inward direction to allow release of the captured crop part.

26. The method according to claim 23, wherein the method provides tilting the cutting blade relative to the orientation of the crop while in the cutting zone profile portion, such that the blade cuts the crop part relatively close to the central stem of the crop.

27. A controller coupled to a device according to claim 1, for controlling the device to carry out a method comprising:
capturing the crop part in the capturing zone profile portion through the capturing opening,
rotating the rotors to transport the crop part in inward direction from the capturing opening towards the cutting zone profile portion, and
while in the cutting zone profile portion the rotors are moving the crop part along the cutter such that the crop part is cut from the crop by a cutting blade of the cutter.

28. An elongated rotor for a device according to claim 1, said rotor being provided with a screw profile along a length of the rotor, having a first longitudinal end which is adapted to be coupled to a drive for rotating the rotor when in operation and being provided with a capturing zone profile portion extending along a portion of the length of the rotor at a second longitudinal end, such that a capturing opening is formed at said second longitudinal end when two of said elongated rotors are held in parallel next to one another.

29. A method for manufacturing an elongated rotor according to claim 28, comprising a step of forming at least a part of said elongated rotor through three-dimensional printing.
